(19) United States
(12) Patent Application Publication
(10) Pub. No.: US 2010/0138307 A1
(43) Pub. Date: Jun. 3, 2010

(54) SYSTEM AND METHOD FOR AUCTIONING ADVERTISING PACKAGES

(76) Inventor: Nicholas B. White, Atlanta, GA (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/377,166

(22) PCT Filed: Aug. 16, 2007
(86) PCT No.: PCT/US07/76070

§ 371 Date: Feb. 11, 2009

Related U.S. Application Data
(60) Provisional application No. 60/838,810, filed on Aug. 18, 2006.

(51) Int. Cl. G06Q 30/00; G06F 17/30

(52) U.S. Cl. 705/14.71; 707/770; 707/E17.032; 707/E17.014

(57) ABSTRACT

A system and method for auctioning multiple advertising units assembled as one or more advertising packages are provided. The method includes the steps of identifying at least one group of potential purchasers of at least one advertising package, notifying one or more potential purchasers about the advertising packages, receiving a bid from a potential purchaser for the advertising packages and indicating one or more winning bids.

### CROSS REFERENCE TO RELATED APPLICATIONS

The present invention claims priority to U.S. Provisional Application Ser. No. 60/838,810 filed on Aug. 18, 2006 which is incorporated herein by reference in its entirety.

### FIELD OF THE INVENTION

The invention relates generally to an auctioning system and method, and in more particular applications to an auctioning system and method for auctioning multiple advertising units assembled as one or more advertising packages.

### BACKGROUND

Advertisements are an important part of a business' marketing plan to inform consumers about the business' goods and/or services. Advertisements have been developed in a wide variety of media formats and locations, including television, radio, print, billboards, websites and the like. With such a wide variety of forms of advertising, it can be difficult for a business to develop an effective advertising plan to market goods and/or services to the appropriate audience.

Oftentimes businesses attempt to create a package of advertisements from an advertising seller. The business purchasing the advertising units (television commercials, print ads, etc.) will create a package of advertising units that they would like to purchase. The advertising seller may be left with single remnant advertising units which can be difficult to sell. Furthermore, the business may not be maximizing the money spent on the advertisements.

Advertising sellers have also attempted to auction individual advertising units through a typical auction system such that the auction is hosted by an auction provider. However, these auctions oftentimes fail to effectively attract the attention of potential advertisement purchasers. Furthermore, these auctions are generally “remnant” auctions for undesirable advertising units.

### SUMMARY

In one embodiment, a method for auctioning multiple advertising units assembled as one or more advertising packages is provided. The method includes the steps of identifying at least one group of potential purchasers of at least one advertising package, notifying one or more potential purchasers about the advertising package(s), receiving a bid from a potential purchaser for the advertising package(s) and indicating one or more winning bids.

According to another embodiment, a method for auctioning multiple advertising units assembled as one or more advertising packages is provided. The method includes the steps of: receiving information describing at least one advertising package from a seller, storing the information in a database, notifying one or more potential purchasers about the information describing the advertising package(s), receiving a bid from a potential purchaser for the advertising package(s) and indicating one or more winning bids.

In accordance with yet another embodiment, a system is provided for auctioning multiple advertising units assembled as one or more advertising packages over the internet. The system includes a database, an electronic notification system and a bid receiving system. The database is suitable for storing information describing at least one advertising package. The electronic notification system is suitable for sending notifications to one or more potential purchasers about the information describing the advertising package(s). The bid receiving system is suitable for receiving a bid from a potential purchaser for the advertising package(s). The database, the electronic notification system and the bid receiving system are located on one or more computerized devices.

Other embodiments are also contemplated as understood by those skilled in the art.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its constructions and operation, and many of its advantages should be readily understood and appreciated.

FIG. 1 is a diagrammatic representation of a seller and multiple advertising packages;

FIG. 2 is a diagrammatic representation of one method for auctioning multiple advertising units assembled as one or more advertising packages;

FIG. 3 is a diagrammatic representation of another method for auctioning multiple advertising units assembled as one or more advertising packages;

FIG. 4 is diagrammatic representation of a more detailed method for auctioning multiple advertising units assembled as one or more advertising packages;

FIG. 5 is a diagrammatic representation of a seller's website;

FIG. 6 is a detailed representation of one embodiment of a seller's website;

FIG. 7 is a representation of a potential purchaser's home page;

FIG. 8 is a representation of a search page;

FIG. 9 is a representation of a search results page;

FIG. 10 is a representation of a detailed listing of an advertising package;

FIG. 11 is a diagrammatic representation of a server; and

FIG. 12 is a diagrammatic representation of potential purchasers communicating with a server.

### DETAILED DESCRIPTION

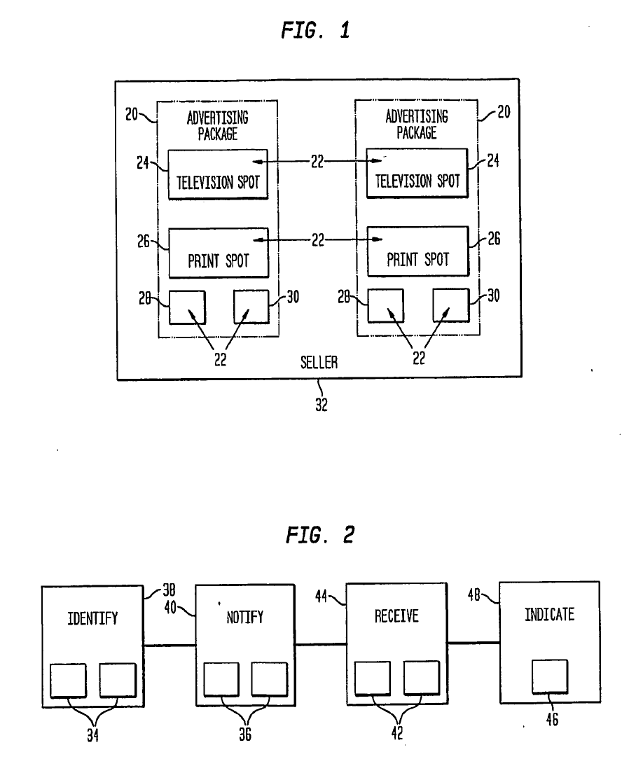

Referring to FIG. 1, a diagrammatic illustration of multiple advertising packages 20 is shown. Each of the advertising packages 20 can be made up of any number of advertising units 22. The advertising units 22 may take a variety of forms, including television advertising spots 24, print advertising spots 26, radio advertising spots 28, website advertising spots 30, as well as other advertising components understood by those skilled in the art. Furthermore, it should be understood that the advertising package 20 can include a single form of advertising unit 22 or multiple forms of advertising units 22. Additionally, each of the spots 24,26,28,30 may include one or more advertising opportunities, such as a merchandizing opportunity. As illustrated in FIG. 1, the advertising packages 20 originate from a single seller 32. However, it should be understood that the seller 32 may only be selling a single advertising package 20. Furthermore, multiple sellers 32 may have advertising packages 20 available. Similarly, multiple sellers 32 may provide one or more advertising units 22 that can be combined into a single advertising package 20.

The advertising package 20 can be determined in any manner understood by those skilled in the art. For example, in one embodiment, the seller 32 may determine which forms and number of each advertising unit to include in the advertising package 20. Illustratively, a television station can create an advertising package 20 having multiple television commercial spots and a website banner ad or other web advertisement appearing on the television station website. In another embodiment, multiple sellers 32 can combine advertising units to create an advertising package 20. A television station and a newspaper company can create a combined advertising package 20 having television commercial spots, website banner advertisements as well as print advertisements appearing in the newspaper.

Referring to FIG. 2, a method for auctioning multiple advertising units 22 assembled as a one or more advertising packages 20 is illustrated diagrammatically. The method includes the steps of identifying at least one group 34 of potential purchasers 36 of at least one advertising package 20, as represented by numeral 38, notifying one or more potential purchasers 36 about at least one advertising package 20, as represented by numeral 40, receiving a bid 42 from a potential purchaser 36 for at least one advertising package 20, as represented by numeral 44, and identifying one or more winning bids 46 of at least one advertising package 20, as represented by numeral 48.

Potential purchasers 36 include any number of different companies, organizations, individuals and the like. The potential purchasers 36 may include parties that may be interested in purchasing advertising units 22 or may be parties that are not interested and/or have not yet purchased advertising units before, yet may conduct business or have interests that may be expressed through advertisements. For example, such potential purchasers 36 may include food and beverage manufacturers, automobile manufacturers and dealers, political groups and the like.

The groups 34 can be determined in a variety of manners understood by those skilled in the art. For example, a database of potential purchasers 36 can be utilized to determine the groups. Specifically, databases can be compiled based on media markets determined by Nielson, Arbitron, IPro, NetGravity and other media ratings services that recognize defined marketplaces. From these databases, one or more groups 34 can be determined based upon the potential purchaser's 36 expected interest and/or previous purchasing history of advertising units 22. It should be noted that the groups 34 can be determined in other manners as understood by those skilled in the art.

In one embodiment, multiple groups 34 can be determined. For example, a premium group can be determined and a non-premium group can be determined. In this embodiment, each of these groups can be treated the same or treated differently.

The one or more groups 34 can be notified in a variety of manners. For example, the groups 34 can be notified through such means as a phone call, fax transmission, in-person meeting, mail, electronic communication and the like. Such forms of electronic communication include email, instant messaging and other forms of electronic communication. Electronic communication, such as email, can be especially convenient for notifying large number of potential purchasers 36 as the names and contact information from the database can be easily imported. The notification may also include an invitation for the potential purchaser 36 to participate in the auction.

In one embodiment having premium and non-premium groups, the premium group can be notified prior to the non-premium group. Furthermore, the premium group may be notified personally, such as through a phone call or in-person meeting. Moreover, the potential purchasers 36 in the premium group can be given additional opportunities, such as by being permitted to enter pre-auction bids and have the opportunity to purchase the advertising package 20 prior to the public start of the auction. The non-premium group may also be notified personally and/or may be notified only through electronic communication, such as via email. Additionally, all groups can be reminded about an upcoming auction prior to the start and/or completion of the auction, such as through electronic communication.

The potential purchasers 36 can be notified regarding a variety of information about the advertising packages 20. This information may include the date, time, location, frequency of occurrence, demographics and other information about the advertising units 22 which make up the advertising package 20. The demographic information may include a breakdown of the ages, sex, income, and other generalized personal information. In one embodiment, if one of the units 22 is a television advertisement, the information may include which show the commercial will air during, the dates and times of the commercials, the length of the commercials, the number of times the commercial will air (multiple times per episode and/or during multiple episodes) as well as the demographic information for the viewers of the show. If one of the units 22 is a billboard, the information may include the location of the billboard, the start and end dates for the advertisement as well as demographic information for the viewers of the billboard. If one of the units 22 is a website advertisement, the information may include the website the advertisement will appear, how frequently and/or what criteria will cause the advertisement to display as well as demographic information for the viewers of the website. It should be understood that additional information may also be given to the potential purchasers 36 when they are notified.

The potential purchasers 36 can search for specific types of advertising packages 20 and/or have advertising packages 20 recommended based upon desired characteristics. For example, a potential purchaser 36 may be interested in specific demographics, such as males aged 18-25. In this regard, the potential purchaser 36 can search the available advertising packages 20 that meet his criteria. This search can be performed in a variety of manners, such as on a computer searching a database of available advertising packages 20. In this embodiment, the search results can be ranked based upon how well each results matches the desired characteristics. In another embodiment, the potential purchaser 36 can establish criteria for the products and/or services he would like to advertise and sell. In this embodiment, the potential purchaser 36 can describe the products and/or services and then have advertising packages 20 recommended. For example, the potential purchaser 36 may wish to advertise a sports car which sells for approximately $50,000. The potential purchaser 36 would have particular advertising packages recommended, such as, for example, packages having television commercials during car racing events or programming with viewers having higher disposable incomes.

The potential purchasers 36 may submit one or more bids 42 that is received by the seller 32 or other party which is providing the auction service. The bids 42 can include a variety of types of bids understood by those skilled in the art. For example, the bids 42 may include an initial bid, an incremental bid, a proxy bid, an automatically increasing bid as well as other forms of bids.

At the close of the auction, there may be one or more winning bids 46. The seller 32 or other party providing the auction service can indicate the one or more winning bids 46. For example, in the instance that there are multiple advertising packages 20, there may be multiple winning bids 46. In this case, the winning bids 46 may be different amounts. Alternatively, a potential purchaser 36 could request all or a specific number of the advertising packages 20 for the winning bid amount if they were the winning bidder. The winning bidder can be notified in any manner as discussed above.

Furthermore, the auction may include other conditions such as a reserve price whereby the reserve price must be met during the bidding to successfully complete the auction. If the reserve price is not met, the seller 32 is not required to provide the advertising package 20. Alternatively, the seller 32 may also have the option to provide the advertising package 20 to the highest bidder at the close of the auction even if the bidding does not meet the reserve price.

The auction may also include a purchase price whereby the auction can be ended prior to the designated closing time should a potential purchaser 36 bid the amount of the purchase price. Therefore, this option permits a potential purchaser to end the auction early and/or prior to the auction starting.

In yet another embodiment, the seller 32 may offer optional add-on advertising units 22 to the winning bidder(s). For example, the seller 32 may offer additional advertising units 22, such as additional television commercials, for an additional price beyond the winning bid 46. This option may be desirable to keep the advertising package appealing to a majority of potential purchasers 36, yet provide flexibility for potential purchasers 36 that desire additional advertising units 22.

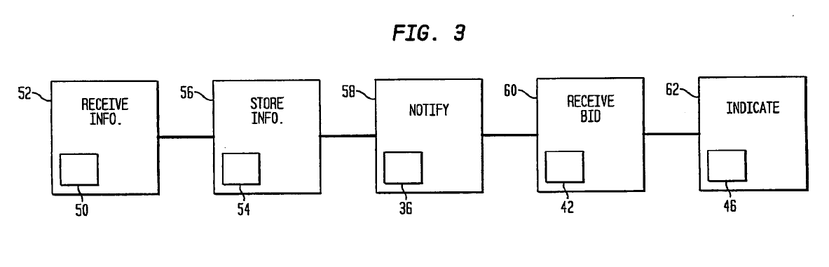

Yet another embodiment of a method for auctioning multiple advertising units 22 assembled as a one or more advertising packages 20 is illustrated diagrammatically in FIG. 3. In this embodiment, the method includes the steps of receiving information 50 describing at least one advertising package 20, as represented by numeral 52, storing the information 50 in a database 54, as represented by numeral 56, notifying one or more potential purchasers 36 about the information 50, as represented by numeral 58, receiving a bid 42 from a potential purchaser 36, as represented by numeral 60 and indicating one or more winning bids 46, as represented by numeral 62. These steps are similar to those described above.

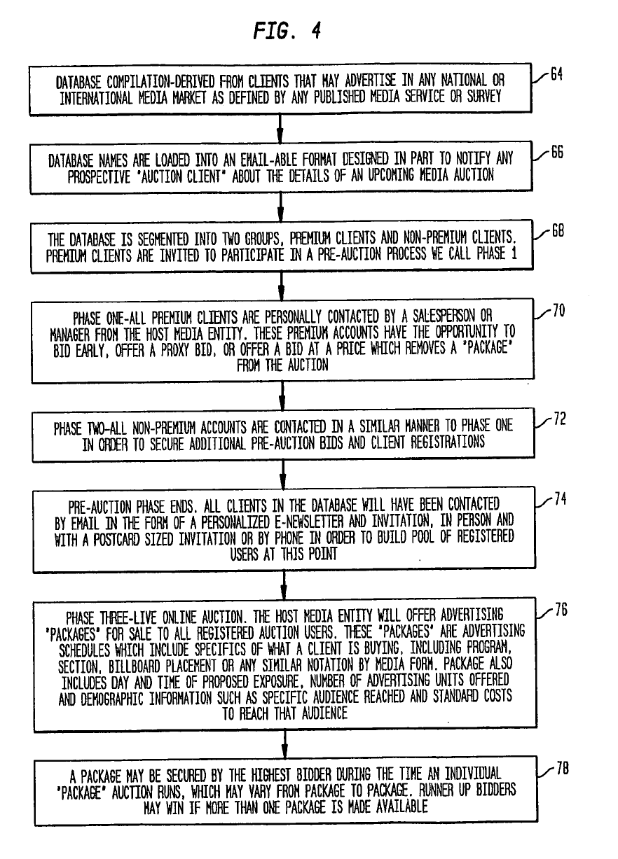

One detailed example of auctioning advertising packages is illustrated in FIG. 4. This embodiment utilizes databases, email and the internet, which will be described in more detail below. As illustrated in FIG. 4, the method begins with step 64 whereby a database of potential purchasers 36 is determined, such as through the use of a media market survey. The potential purchasers 36 are loaded into an emailable format, as shown in step 66. If desired, the database can be split into one or more groups. For example, as shown in step 68, the database can be split into two groups, premium and non-premium. In this embodiment, the premium clients can be personally contacted, as shown in step 70, as those clients are expected to be more interested in the advertising packages 20 and thus may be more likely to bid on the advertising packages 20. In this regard, the premium potential purchasers are given the opportunity to bid early, offer a proxy bid and/or enter a bid sufficient to purchase the advertising package 20 from the auction.

After all of the premium potential purchasers have been contacted, the non-premium purchasers will be contacted, as shown in step 72. The non-premium potential purchasers can be personally contacted, just as with the premium potential purchasers, or they may instead be contacted just through email. Additionally, as shown in step 74, regardless of the manner of contact, both the premium and non-premium groups may also be contacted through email, which will provide information about the advertising packages and will provide an invitation to the potential purchasers to either log in to their account and/or register to bid on the auction. The seller 32 will then be able to start the auction. As illustrated in step 76, in this embodiment, the auction is held online. Finally, the auction ends, as in step 78. In this embodiment, the highest bidder wins at least one advertising package 20, assuming the reserve price, if required, is met. Runner up bidders may also have an opportunity to win if more than one package is available and if the winning bidder does not want the packages 20 at the winning bid price.

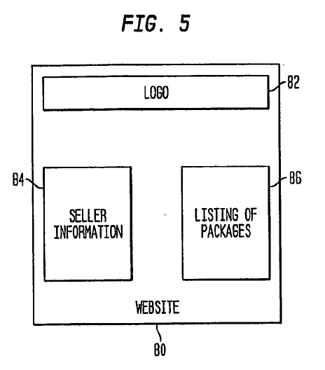

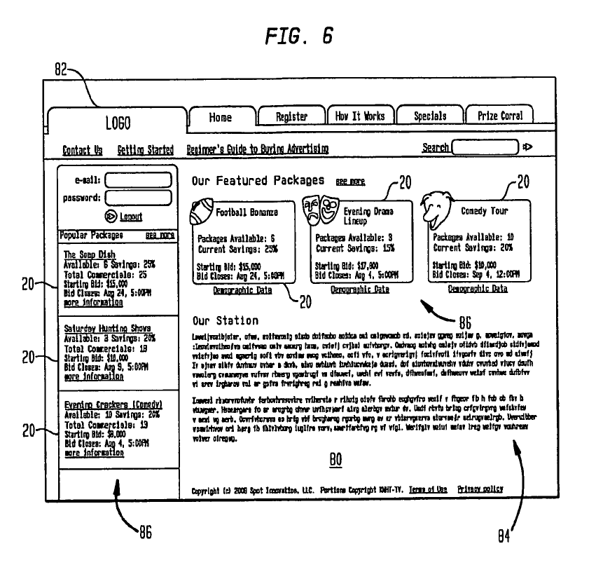

One embodiment of a seller's auction website 80 is illustrated in FIGS. 5 and 6. In this embodiment, the website 80 can include a variety of attributes affiliated with the seller 32. For example, the website 80 can include the seller's logo 82, colors, and other design attributes affiliated with the seller 32. Furthermore, the website 80 can include information 84 about the seller 32, such as contact information, the general demographics of seller's audience and the like. Additionally, the website 80 can include a listing 86 of available advertising packages 20. In this regard, the potential purchasers 36 can be provided with a link to the website 80 whereby the potential purchasers 36 can further review the advertising package 20 as well as other available advertising packages 20 from the seller 32. In one embodiment, this link is provided to the potential purchasers 36 via email.

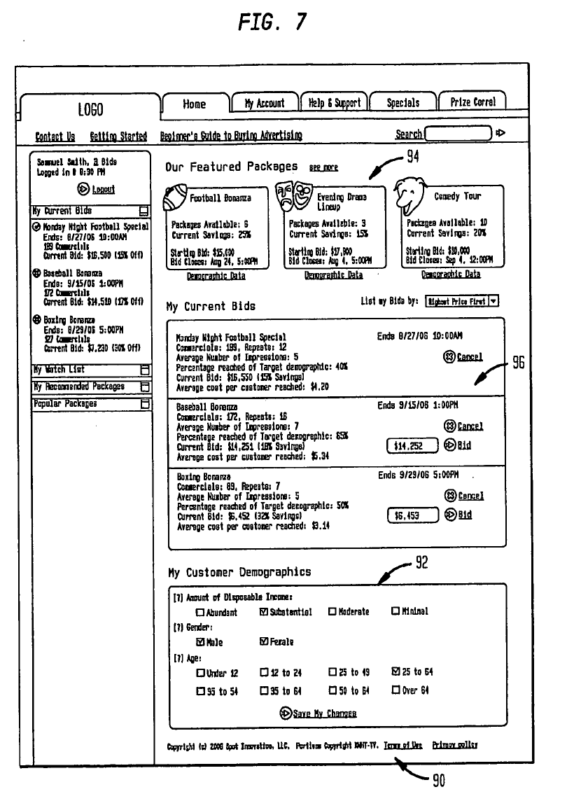

Potential purchasers 36 can log into the website 80 in any conventional manner, such as, for example, by providing a user name and password. Once logged in to the website 80, each potential purchaser 36 will have a specific personal page 90, as shown in FIG. 7. This page 90 can provide a variety of information concerning the potential purchaser's preferences 92. The preferences 92 can include a variety of general demographic information the potential purchaser 36 considers important for advertising. For example, the preferences 92 might include age, sex, income, and other factors understood by those skilled in the art. The preferences 92 can thereby be utilized to provide recommended packages 94. Generally, the recommended packages 94 summarize advertising packages 20 that are available that the potential purchaser 36 may or may not be aware of and that fall within the potential purchaser's preferences 92. Furthermore, the page 90 can also summarize any advertising packages 20 the potential purchaser 36 has bid on, as shown at 96. From the summary 96, the potential purchaser 36 can increase the bid, cancel the bid and perform other functions as understood by those skilled in the art. The page 90 may also provide other information concerning the potential purchaser 36, such as bidding history, watch lists, auctions won and other information understood by those skilled in the art.

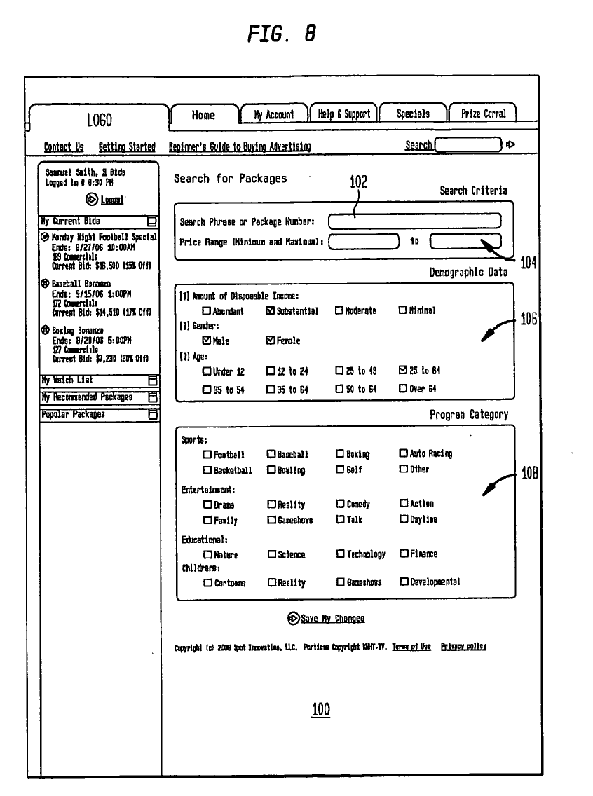

The potential purchasers 36 will be able to search the website 80 in a variety of manners. In one embodiment, the search will be carried out only for advertising packages 20 available from a single seller 32. In an alternative embodiment, the search will be carried out for advertising packages 20 available from multiple sellers 32. One embodiment of a search page 100 is illustrated in FIG. 8. In this embodiment, the potential purchaser 36 can search by a variety of areas. For example, the potential purchaser 36 can search by keyword 102, price 104, demographic information 106, program category 108, as well as other areas understood by those skilled in the art. It should be understood that other forms of searching is also contemplated as understood by those skilled in the art.

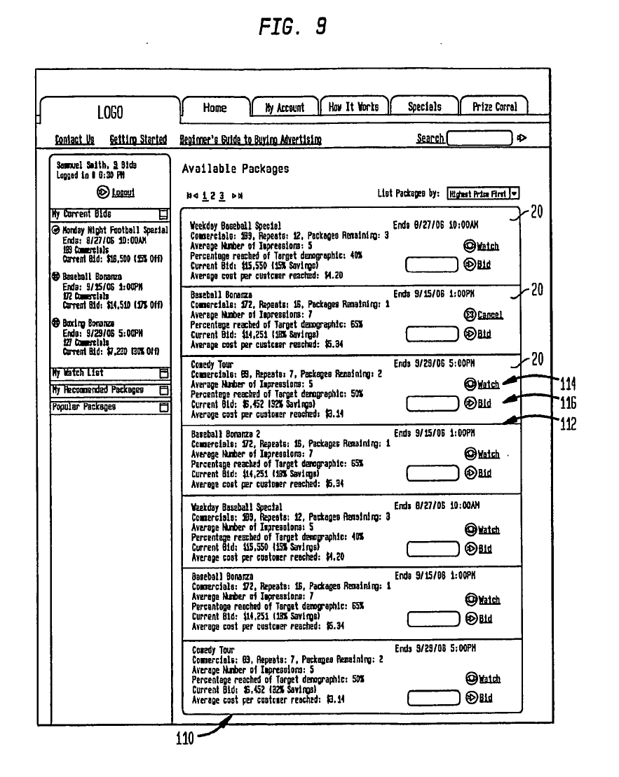

After performing a search, such as via search page 100, the search results can be provided to the potential purchaser 36 in a variety of manners. One embodiment of a search result is illustrated as result page 110 in FIG. 9. Result page 110 summarizes, in the form of list 112, available advertising packages 20 which may fall within the search criteria. The list 112 can include one or more packages 20 and can includes information about the package 20, such as current bid, end time, percentage of target demographic that the package meets and the like. Furthermore, the list 112 can include links 114,116 whereby the potential purchaser 36 can watch and/or bid on the package 20. Additionally, the search results can be sorted in a variety of manners, such as by cost, end date, percentage of target demographic and the like.

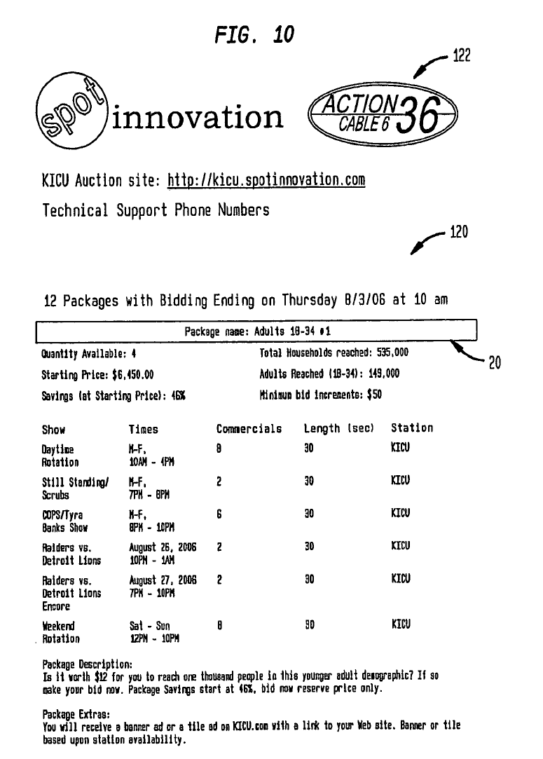

The result page 110 can also link to more detailed information about the packages 20, such as shown on detailed page 120, in FIG. 10. As shown in this figure, further details concerning the advertising packages 20 are provided. Furthermore, the page includes attributes of the seller 32, such as logo 122. It should be noted that these attributes can be included on any number of pages such that it appears that the seller 32 is providing the page and/or auction service.

The system and/or website can be hosted in a variety of manners understood by those skilled in the art. In one embodiment as shown in FIG. 11, the system and/or website is hosted by the seller 32. In another embodiment, the system and/or website is hosted by an auction host. In one embodiment, a server 130 includes a central processing unit (CPU) 132, a database 134, an electronic notification system 136 and a bid receiving system 138. While the CPU 132, database 134, electronic notification system 136 and bid receiving system 138 are illustrated as being located on a single server 130, it should be understood that these components may be located on multiple servers or other electronic devices as understood by those skilled in the art.

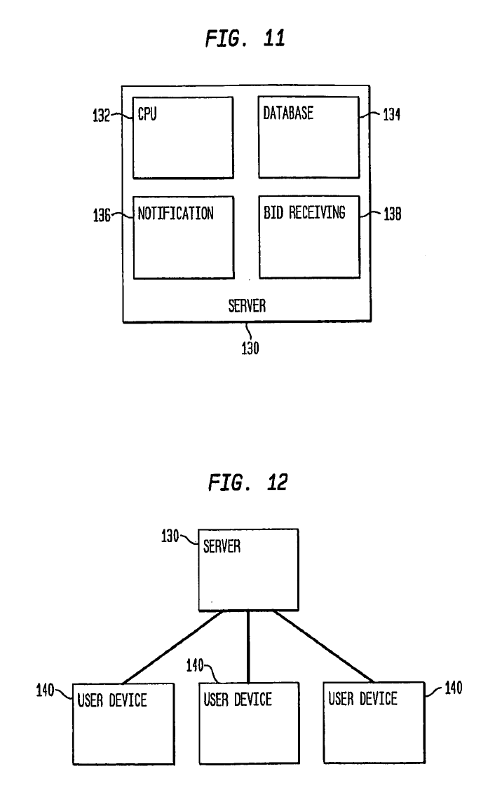

In the embodiment of a single server 130, the potential purchasers 36 will communicate with the server through user devices 140, such as shown in FIG. 12. Each potential purchaser 36 can communicate with the server 130 via one or more user devices 140 via the internet or other electronic communications format. The user devices may include a variety of electronic devices such as, for example, computers, laptops, personal digital assistances, cellular phones, facsimile machines and the like as understood by those skilled in the art.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for auctioning multiple advertising units assembled as one or more advertising packages, the method comprising the steps of:
identifying at least one group of potential purchasers of at least one advertising package;
notifying one or more potential purchasers about the at least one advertising package;
receiving a bid from a potential purchaser for the at least one advertising package; and
indicating one or more winning bids of the at least one advertising package.

2. The method of claim 1 wherein the one or more advertising packages includes at least one advertising unit selected from the group consisting of television advertisements, radio advertisements, print advertisements and web advertisements.

3. The method of claim 1 wherein the step of identifying one or more potential purchasers comprises identifying a premium potential purchaser group and a non-premium potential purchaser group.

4. The method of claim 3 wherein the premium potential purchaser group is notified before the non-premium potential purchaser group.

5. The method of claim 3 further comprising the step of permitting the premium potential purchaser group to submit pre-auction bids and purchase the at least one advertising package before the non-premium potential purchaser group is notified.

6. The method of claim 1 wherein at least the steps of notifying one or more potential purchasers and receiving a bid from a potential purchaser are performed via the internet.

7. The method of claim 1 further comprising the step of providing a listing of advertising packages which is searchable according to one or more advertising characteristics.

8. The method of claim 7 further comprising the step of providing a search result of at least one advertising package, the search result including at least one attribute affiliated with a seller of the at least one advertising package.

9. The method of claim 1 wherein the step of notifying one or more potential purchasers includes an invitation to each of the one or more potential purchasers to participate in an auction for the at least one advertising package.

10. A method for auctioning multiple advertising units assembled as one or more advertising packages, the method comprising the steps of:
receiving information describing at least one advertising package from a seller;
storing the information in a database;
notifying one or more potential purchasers about the information describing the at least one advertising package;
receiving a bid from a potential purchaser for the at least one advertising package; and
indicating one or more winning bids of the at least one advertising package.

11. The method of claim 10 wherein the one or more advertising packages includes at least one advertising unit selected from the group consisting of television advertisements, radio advertisements, print advertisements and web advertisements.

12. The method of claim 10 wherein the step of notifying one or more potential purchasers comprises notifying a premium potential purchaser group and a non-premium potential purchaser group.

13. The method of claim 12 wherein the premium potential purchaser group is notified before the non-premium potential purchaser group.

14. The method of claim 12 further comprising the step of permitting the premium potential purchaser group to submit pre-auction bids and purchase the at least one advertising package before the non-premium potential purchaser group is notified.

15. The method of claim 10 wherein at least the steps of notifying one or more potential purchasers and receiving a bid from a potential purchaser are performed via the internet.

16. The method of claim 10 further comprising the step of providing a listing of advertising packages which is searchable according to one or more advertising characteristics.

17. The method of claim 16 further comprising the step of providing a search result of at least one advertising package, the search result including at least one attribute affiliated with a seller of the at least one advertising package.

18. The method of claim 10 wherein the step of notifying one or more potential purchasers includes an invitation to each of the one or more potential purchasers to participate in an auction for the at least one advertising package.

19. A system for auctioning multiple advertising units assembled as one or more advertising packages over the internet, the system comprising:
a database for storing information describing at least one advertising package;
an electronic notification system for sending notifications to one or more potential purchasers about the information describing the at least one advertising package; and
a bid receiving system for receiving a bid from a potential purchaser for the at least one advertising package,
wherein the database, the electronic notification system and the bid receiving system are located on one or more computerized devices.

20. The system of claim 19 wherein the one or more advertising packages includes at least one advertising unit selected from the group consisting of television advertisements, radio advertisements, print advertisements and web advertisements.

21. The system of claim 19 wherein the electronic notification system and the bid receiving system are each connected to the internet.

22. The system of claim 19 further comprising a central processing unit (CPU) operably coupled to the database to search the database according to one or more advertising characteristics.

23. The system of claim 22 wherein the CPU is capable of providing a search result of at least one advertising package, the search result taking the form of a web page including at least one attribute affiliated with a seller of the at least one advertising package.

24. The system of claim 19 wherein the electronic notification system sends an invitation to each of the one or more potential purchasers to participate in an auction for the at least one advertising package.

25. The system of claim 19 wherein the database, the electronic notification system and the bid receiving system are located on a single computerized server.

26. The system of claim 19 wherein the database, the electronic notification system and the bid receiving system are located on separate computerized servers.
